(19) United States
(12) Patent Application Publication
(10) Pub. No.: US 2025/0375921 A1
(43) Pub. Date: Dec. 11, 2025

(54) METHOD OF PRODUCING A DENTAL OBJECT

(71) Applicant: Ivoclar Vivadent AG, Schaan (LI)

(72) Inventors: Jonas REINHARDT, Igis (CH); Nicola BITAR, Montlingen (CH); Christian RITZBERGER, Grabs (CH)

(21) Appl. No.: 19/231,840

(22) Filed: Jun. 9, 2025

(30) Foreign Application Priority Data
Jun. 10, 2024 (EP) 24181133.0

(51) Int. Cl. B28B 17/00; B28B 1/00; B33Y 10/00; B33Y 30/00; B33Y 40/20; B33Y 50/02; B33Y 80/00

(52) U.S. Cl. CPC B28B 17/0081; B28B 1/001; B33Y 10/00; B33Y 30/00; B33Y 40/20; B33Y 50/02; B33Y 80/00

(57) ABSTRACT

A method of producing a dental object, including the steps of printing (S101) a printing layer of the dental object; evaporating (S102) a solvent of the printed printing layer; and detecting (S103) a temperature profile during evaporation of the solvent.

### CROSS-REFERENCE TO RELATED APPLICATIONS

This application claims priority to European patent application No. 24181133.0 filed on Jun. 10, 2024, which disclosure is incorporated herein by reference in its entirety.

### TECHNICAL FIELD

The present invention relates to a method of producing a dental object and a printer for producing the dental object.

### SUMMARY

Drying or evaporating inorganically filled carrier liquids on the basis of polar or non-polar solvents, such as water, ethanol, ethylene glycol or their mixtures, is a challenge and takes a considerable amount of time in three-dimensional printing. For this reason, each individual printing layer should be dried as quickly as possible.

In general, it is difficult to determine when a printing layer is completely dry. As a rule, empirical values are used to determine the appropriate drying time for each printing layer. However, reliable monitoring of the degree of drying is not carried out. In principle, the carrier liquid should be dried in such a way that mechanical solidification and no cracks occur. US2022331873 is directed to additive manufacturing and is hereby incorporated by reference.

It is the technical task of the present invention to improve a three-dimensional printing process.

This technical task is solved by subject-matter according to the independent claims. Technically advantageous embodiments are the subject-matter of the dependent claims, the description and the drawings.

According to a first aspect, the technical task is solved by a method of producing a dental object, comprising the steps of printing a printing layer of the dental object; evaporating a solvent of the printed printing layer; and detecting a temperature profile during evaporation of the solvent. The method achieves the technical advantage that the drying of a solvent-based carrier liquid in the printing layer can be monitored and controlled.

In a technically advantageous embodiment of the method, the method is controlled based on the detected temperature profile. This achieves the technical advantage, for example, that active regulation or control of the printer can be carried out based on an exothermic or endothermic reaction of the printing layer.

In a further technically advantageous embodiment of the method, the next printing layer is printed when a temperature of the temperature profile reaches a predetermined value. This achieves the technical advantage, for example, that the method can be continued immediately when the predetermined temperature or temperature profile is reached.

In a further technically advantageous embodiment of the method, an air flow is directed onto the printing layer to evaporate the solvent. This achieves the technical advantage, for example, that the evaporation of the solvent can be accelerated and a temperature drop is increased.

In a further technically advantageous embodiment of the method, an air flow to the printing layer is controlled based on the detected temperature profile. This achieves the technical advantage, for example, that the air flow can be adjusted depending on the temperature profile.

In a further technically advantageous embodiment of the method, the temperature, the humidity or the supplied air volume of the air flow is controlled based on the detected temperature profile. This achieves the technical advantage, for example, that particularly suitable parameters of the air flow can be changed.

In a further technically advantageous embodiment of the method, the printing layer is kept between a maximum temperature and a minimum temperature. This achieves the technical advantage, for example, that the melting of a support material can be prevented.

In a further technically advantageous embodiment of the method, the temperature profile is detected by an infrared camera or a sensor for electromagnetic radiation. This achieves the technical advantage, for example, that the temperature profile can be detected efficiently and the drying can be adjusted depending on the construction height.

In a further technically advantageous embodiment of the method, the temperature profile is detected by a self-learning algorithm. This achieves the technical advantage, for example, that an algorithm can be used instead of an infrared sensor, thus reducing the effort involved.

In a further technically advantageous embodiment of the method, the detected temperature profile is compared with a predetermined temperature profile. This achieves the technical advantage, for example, that deviations between the predetermined temperature profile and the detected temperature profile can be determined.

In a further technically advantageous embodiment of the method, a thickness or moisture of the printing layer or amount of the carrier liquid is determined based on the comparison. This achieves the technical advantage, for example, that information about printing properties can be obtained from the temperature profile.

In a further technically advantageous embodiment of the method, a function of the print head is determined based on the comparison. This achieves the technical advantage, for example, that a malfunction of the print head or individual print nozzles can be identified. A drop size of the print head can also be determined.

According to a second aspect, the technical task is solved by a printer for producing a dental object, comprising an evaporation element for evaporating a solvent of the printed printing layer; and a detection element for detecting a temperature profile during evaporation of the solvent. The printer achieves the same technical advantages as the method according to the first aspect.

In a technically advantageous embodiment of the printer, the printer comprises an infrared camera or a sensor for electromagnetic radiation for detecting the temperature profile.

In a further technically advantageous embodiment of the printer, the printer comprises a fan for generating an air flow onto the printing layer. This achieves the technical advantage, for example, that the evaporation of the solvent can be accelerated and a temperature drop is increased in the temperature profile. This temperature drop, which is generated by the fan on the surface of the printing layer, can be used to draw conclusions about the solvent content of the printing layer. The renewed increase in the temperature of the printing layer indicates that the solvent content in the printing layer is decreasing.

### BRIEF DESCRIPTION OF THE DRAWINGS

Exemplary embodiments of the invention are shown in the drawings and are described in more detail below, in which:

FIG. 1 shows a schematic view of a structure of a 3D printer with cooling;

FIG. 2 shows a schematic diagram of the surface temperature during drying of a printing layer; and

FIG. 3 shows a block diagram of a method of producing a dental object.

### DETAILED DESCRIPTION

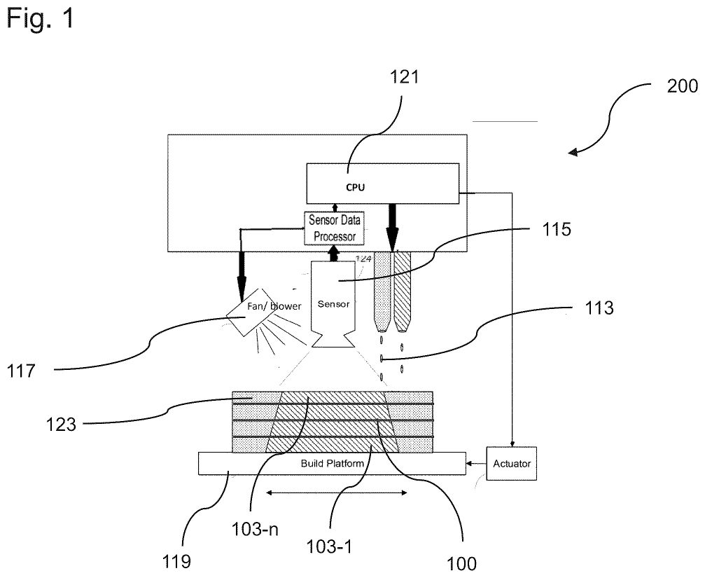

FIG. 1 shows a schematic view of a structure of a 3D printer 200. The printer 200 applies a carrier liquid 113 in successive printing layers 103-1, . . . , 103-n to the movable build platform 119 in order to produce the dental object 100.

The printing layer 103-1, . . . , 103-n can be composed of a carrier liquid 113 with monophase or multiphase inorganic material, such as doped partially or fully stabilized zirconium oxide (stabilizers: Y3+, La3+, Mg2+, Ca2+, Ce3+ or Ce4+ or combinations thereof), or of aluminum oxide or MgO-doped aluminum oxide or a combination thereof (inorganic composite).

The carrier liquid 113 may also contain an organic additive that positively influences the drying and increases the strength of the dental object 100 in the unsintered state, such as diols, triols, polyvinyl alcohols, polyethylene glycols, polyacrylates, polyvinyl pyrolidones and cellulose derivatives.

The drying times of the printing layers 103-1, . . . , 103-n vary due to a different amount of carrier liquid 113, a construction height, a build platform temperature, or a solids content used for a printing layer 103-1, . . . , 103-n, respectively. For each printing layer 103-1, . . . , 103-n, a different amount of the carrier liquid 113 is applied, since each printing layer 103-1, . . . , 103-n is formed by a different two-dimensional pattern (sliced image).

In general, it is difficult to determine the drying state of the carrier liquid 113 at different points. Various external influences, such as temperature or humidity, also have an effect on the drying behavior of the carrier liquid 113.

An infrared camera or an electromagnetic radiation sensor is used as a detection element 115 to determine the temperature profile 107 over time of a new wet printing layer 103-1, . . . 103-n, while an air flow is blown onto the printing layer 103-1, . . . , 103-n using a fan 117 as an evaporation element. The air flow can be either cold or warm air. The detection element 115 generates a time sequence of digital data that reflects the temperature of the printing layer.

The air flow generated on the surface of the new printing layer 103-1, . . . , 103-n accelerates the evaporation of water, which is used as a solvent. The accelerated evaporation causes the printing layer 103-1, . . . , 103-n to cool. This effect is referred to as evaporative cooling, evaporative enthalpy or evaporation chill. The energy required for evaporation is extracted from the printing layer 103-1, . . . , 103-n. Therefore, the evaporation process causes the printing layer 103-1; . . . , 103-n to cool.

The generated air flow removes vapor-saturated air and supplies unsaturated air, so that the higher difference in chemical potential or concentration gradient favors further evaporation. When air is in motion, which has not yet reached a maximum capacity for absorbing the solvent and encounters the wet printing layer 103-1, . . . , 103-n with the solvent, it absorbs the solvent as evaporation gas.

The air flow thus increases the temperature difference on the surface of the printing layer 103-1, . . . , 103-n, so that a temperature profile with a lower temperature minimum is detected. This leads to an improved sensitivity of the measurement. The temperature profile can then be used to determine whether printing of the next printing layer 103-n+1 can begin.

This saves time and enables higher quality drying of the printing layer 103-1, . . . 103-n. Drying too quickly, on the other hand, can lead to cracks in the printing layer 103-1, . . . 103-n. This is a problem with ceramic green bodies (bodies in the unsintered state), as the green density is in the range of 40-60% in relation to the theoretical final density. Cracks in the unsintered green body lead to insufficient final strength after the sintering process.

The control unit 121 (controller) is used to control the printer 200 and to perform calculations. The control unit 121 can perform different controls depending on the carrier liquid 113, since different carrier liquids 113 react differently to an air flow, humidity and heat. For this purpose, the control unit 121 comprises, for example, a central processing unit (CPU) and a digital memory for storing programs and data, such as for storing temperature profile data.

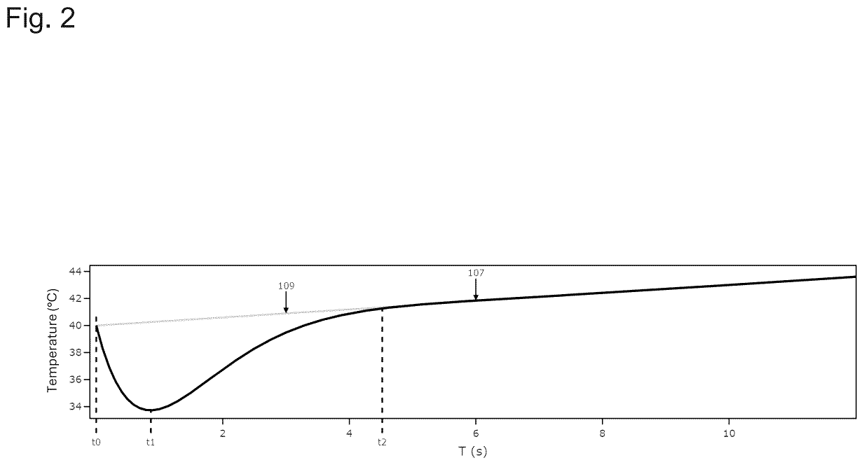

FIG. 2 shows a schematic diagram of the temperature profile 107 during drying of a printing layer 103-1, . . . , 103-n with water evaporation by an air flow and a temperature profile 109 without air flow. Based on the temperature profile 107, the evaporative cooling can be used to determine which drying stage the applied printing layer 103-1, . . . , 103-n is currently in. Initially, the surface temperature drops to a minimum until it rises again after a certain time.

From the time to, strong cooling takes place due to water evaporation. The evaporating water draws heat energy from the printing layer 103-1, . . . , 103-n, so that the temperature of the printing layer 103-1, . . . , 103-n decreases. The decrease in temperature depends on an air flow, for example how strongly a fan acts on the printing layer 103-1, . . . , 103-n. At time t1 in the minimum of the profile, water evaporation has ended and the temperature of the printing layer 103-1, . . . , 103-n rises again. At time t2, the next printing layer 103-n+1 is applied as soon as a predetermined temperature is reached.

The cooling of the printing layer 103-1, . . . , 103-n is detected and recorded by the detection element 115. This produces the characteristic temperature profile curve 107, which shows the progression of the surface temperature of the printing layer 103-1, . . . , 103-n over time.

With the evaporation of the solvent and the recording of the temperature profile 107, the exact drying status of the printing layer 103-1, . . . , 103-n can be determined. Based on the temperature profile 107, the printing process can be controlled in different ways and at different times.

Based on the temperature profile 107, for example, the optimum time for printing the next printing layer 103-n+1 can be actively determined for each printing layer 103-1, . . . , 103-n. The data of the temperature profile is stored, for example, as digital data in a memory of the control unit 121.

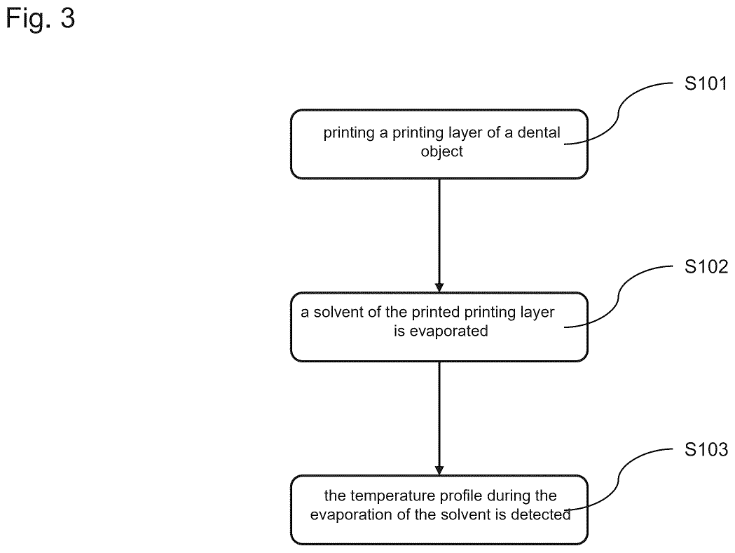

FIG. 3 shows a diagram of the measurement of the surface temperature during drying of a printing layer 103-1, . . . , 103-n. The solids content is 70% by weight, water approx. 27% by weight and binder approx. 3% by weight. The density of the printing layer 103-1, . . . , 103-n is 2.4 g/cm³ to 3.6 g/cm³ without taking into account the organic components for yttrium-stabilized ZrO2. If the organic components are taken into account, the density is lower.

In the diagram shown, an air flow with an air volume of 5 l/min and a temperature of 50° C. is generated. The relative humidity is less than 60%. With a zirconium slurry as carrier liquid 113 with a water content of 30% by weight and a thickness of the printing layer 103-1, . . . , 103-n of 6 μm, a drop in temperature of 10° C. is determined after printing. After a period of time, the temperature difference between the surface of the printing layer 103-1, . . . , 103-n and the printed printing layer 103-1, . . . , 103-n decreases to 0° C.

The temperature profile 107 can be used to detect whether the print head has dispensed no or too little carrier liquid 113. If, for example, no characteristic temperature profile 107 with a minimum is detected in a printed area, the print head has not dispensed any carrier liquid 113 there. In this way, nozzle failures of the print head can be determined. A single pixel or nozzle failure can be determined. It is also possible to detect whether a uniform layer application is present. The print head is not blown on to prevent the nozzles from clogging or drying. An ideal process window favors coalescence, i.e. the bonding of the individual layers and crack-free drying.

The method is independent of air conditioning in the installation space. It is therefore possible to print in different environments, such as at different temperatures and humidity levels, without reducing the quality of the print. Room air conditioning can therefore be dispensed with.

It is also possible to keep support material 123 used, such as wax, in a predetermined temperature window between a maximum temperature and a minimum temperature during the printing process of the printing layer 103-1, . . . , 103-n. Excessive cooling of the support material 123 can result in shrinkage, for example. This reduces the printing accuracy of the dental object 100. If, on the other hand, the support material 123 becomes too hot, it melts. In these cases, the dental object 100 is also not printed with the desired accuracy. The entire layer structure then has the same temperature as the build platform.

Furthermore, it is possible to use the position of the minimum in the temperature profile 107 or the drying time to detect the thickness to which the carrier liquid 113 was applied, i.e. the printing layer 103-1, . . . , 103-n was printed. In addition, the solids content of the carrier liquid 113 can be determined or whether it changes during printing. This can be detected in the temperature profile 107 by the fact that the carrier liquid 113 dries in a shorter or longer time than specified by a reference value.

In addition, a standardized test print can be performed for which the parameters are predefined. If the measured parameters in the temperature profile 107 deviate from the specified parameters, the carrier liquid 113 has a different composition than required. In this way, an unsuitable carrier liquid 113 can be detected and a warning can be issued to the user that the carrier liquid 113 does not comply with the specified standards.

In order to achieve homogeneous and crack-free drying of the printing layer 103-1, . . . , 103-n, the carrier liquid 113 must not dry too quickly in the liquid state. For this purpose, the amount of air supplied, the temperature or the degree of humidity of the air flow can be adjusted in the respective drying phase. Depending on the drying status, for example, the amount of air can be reduced and then increased again.

The temperature of the supplied hot air can also be reduced until the carrier liquid 113 has a certain strength and can no longer form cracks. The temperature can then be increased again so that the carrier liquid 113 quickly reaches the correct temperature for the next printing layer 103-n+1.

FIG. 3 shows a block diagram of the method of producing the dental object 100. The method comprises the step S101 of printing a printing layer 103-1, . . . , 103-n of the dental object 100. In step S102, the solvent 105 of the printed printing layer 103-1, . . . , 103-n is evaporated. In step S103, the temperature profile 107 during the evaporation of the solvent 105 is detected.

The method allows the degree of drying and the evaporation process to be monitored with high accuracy. The process of building up ceramic printing layers 103-1, . . . , 103-n layer by layer can be performed accordingly in a controlled manner in order to avoid inhomogeneous drying or the propagation of cracks.

The method can be used to dry the printing layer 103-1, . . . , 103-n quickly and without cracks. Measuring the drying status by means of the temperature profile 107 enables further control to speed up or slow down the drying process. This allows printing at a higher speed, better quality and with fewer rejects. The method is independent of humidity and air pressure. Therefore, no air conditioning is required and the method is more resource-efficient.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### REFERENCE LIST

100 Dental object
103 Printing layer
105 Solvent
107 Temperature profile
109 Temperature profile without drying
111 Evaporation element
113 Carrier liquid
115 Detection element
117 Fan
119 Build platform
121 Control unit
123 Support material
200 Printer

1. A method of producing a dental object, comprising the steps of:
printing a printing layer of the dental object;
evaporating a solvent of the printed printing layer; and
detecting a temperature profile during evaporation of the solvent.

2. The method according to claim 1, wherein the method is controlled based on the detected temperature profile.

3. The method according to claim 1, wherein the next printing layer is printed when a temperature of the temperature profile reaches a predetermined value.

4. The method according to claim 1, wherein an air flow is directed onto the printing layer to evaporate the solvent.

5. The method according to claim 4, wherein the air flow is controlled based on the detected temperature profile.

6. The method according to claim 5, wherein temperature, humidity or a supplied air volume of the air flow is controlled based on the detected temperature profile.

7. The method according to claim 1, wherein the printing layer is kept between a maximum temperature and a minimum temperature.

8. The method according to claim 1, wherein the temperature profile is detected by an infrared camera or a sensor for electromagnetic radiation.

9. The method according to claim 1, wherein the temperature profile is detected by a self-learning algorithm.

10. The method according to claim 1, wherein the detected temperature profile is compared with a predetermined temperature profile.

11. The method according to claim 10, wherein a thickness or moisture of the printing layer or amount of the carrier liquid is determined based on the comparison.

12. The method according to claim 10, wherein a function of the print head is determined based on the comparison.

13. A printer for producing a dental object, comprising:
an evaporation element for evaporating a solvent of the printed printing layer; and
a detection element for detecting a temperature profile during evaporation of the solvent.

14. The printer according to claim 13, wherein the printer comprises an infrared camera or a sensor for electromagnetic radiation for detecting the temperature profile.

15. The printer according to claim 13, wherein the printer comprises a fan for generating an air flow onto the printing layer.
